(19) United States
(12) Patent Application Publication
(10) Pub. No.: US 2018/0260461 A1
(43) Pub. Date: Sep. 13, 2018

(54) MULTI-PLATFORM DATA MINING SOFTWARE

(71) Applicant: David Stephens, Los Angeles, CA (US)

(72) Inventor: David Stephens, Los Angeles, CA (US)

(21) Appl. No.: 15/917,132

(22) Filed: Mar. 9, 2018

Related U.S. Application Data
(60) Provisional application No. 62/470,090, filed on Mar. 10, 2017.

(51) Int. Cl. G06F 17/30

(52) U.S. Cl. CPC G06F 17/30572; G06F 17/30563; G06F 17/30539

(57) ABSTRACT

The present invention is a data mining solution for scientists, engineers, and technical professionals that can operate across multiple platforms and assimilate multiple formats to create a single data presentation that can be readily used by the user. The invention also offers a standardized format that can be used throughout industries for data transfer and storage that can greatly simplify exchange of information in the future among companies, universities, and the like. Specifically, the present invention gathers data from several disparate data files and file types into a single spreadsheet workbook, and then offers a variety of features to perform statistical analysis and graphing of the data during import.

### CROSS-REFERENCES TO RELATED APPLICATIONS

This application claims priority from U.S. Application No. 62/470,090, filed Mar. 10, 2017, the contents of which are incorporated by reference in its entirety.

### BACKGROUND

Data mining is the process of collecting and analyzing data from different sources and presenting the critical data in a useful form. Many large companies rely on technical data to generate reports every day, but collecting the data to produce those reports can be a time consuming and cost-ineffective project due to the unwieldy manner in which data is stored, retrieved, categorized, and analyzed. Data mining simplifies and makes more efficient that task by collecting the necessary data in the most effective manner so that it can be analyzed properly without undue waste sorting through records, meshing different formats, and weeding out improper search results. Data mining may also be thought of as the process of finding correlations or patterns among dozens of quasi-related fields in large relational databases.

Technical data can refer to any facts, numbers, or text that can be processed by a computer. Today, organizations are accumulating vast and growing amounts of data in different formats and different databases. This includes: operational or transactional data such as sales, cost, inventory, payroll, and accounting; nonoperational data, such as industry sales, forecast data, and macro-economic data; meta data—data about the data itself, such as logical database design or data dictionary definitions. Scientific data can also vary dramatically depending upon the technical field and the type of document in which the data is stored. However, due to the overlap in many scientific and technical disciplines, it is often useful to extract data in one field (say, e.g., meteorology) for analysis in another field (such as aerospace), The patterns, associations, or relationships among all this data can provide useful information once it is extracted and presented in a useable and readable format.

Dramatic advances in data capture, processing power, data transmission, and storage capabilities are enabling organizations to integrate their various databases into data warehouses. Data warehousing may be described as a process of centralized data management and retrieval. Data warehousing, like data mining, is a relatively new term although the concept itself has been around for years. Dramatic advances in data analysis software are allowing users to access this data freely. The data analysis software is what supports data mining.

While large-scale information technology has been evolving separate transaction and analytical systems, data mining provides a link between the two. Data mining software analyzes relationships and patterns in stored transaction data based on open-ended user queries. Several types of analytical software are available: statistical, machine learning, and neural networks. Generally, any of four types of relationships are sought:

Classes: Stored data is used to locate data in predetermined groups. For example, a restaurant chain could mine customer purchase data to determine when customers visit and what they typically order. This information could be used to increase traffic by having daily specials.

Clusters: Data items are grouped according to logical relationships or consumer preferences. For example, data can be mined to identify market segments or consumer affinities.

Associations: Data can be mined to identify associations. The weather-aerospace example is an example of associative mining.

Sequential patterns: Data is mined to anticipate behavior patterns and trends. For example, an outdoor equipment retailer could predict the likelihood of a backpack being purchased based on a consumer's purchase of sleeping bags and hiking shoes.

Data mining consists of five major elements:

1) Extract, transform, and load transaction data onto the data warehouse system.

2) Store and manage the data in a multidimensional database system.

3) Provide data access to business analysts and information technology professionals.

4) Analyze the data by application software.

5) Present the data in a useful format, such as a graph or table.

There are different levels of analysis that are available:

Artificial neural networks: Non-linear predictive models that learn through training and resemble biological neural networks in structure.

Genetic algorithms: Optimization techniques that use processes such as genetic combination, mutation, and natural selection in a design based on the concepts of natural evolution.

Decision trees: Tree-shaped structures that represent sets of decisions. These decisions generate rules for the classification of a dataset. Specific decision tree methods include Classification and Regression Trees (CART) and Chi Square Automatic Interaction Detection (CHAID). CART and CHAID are decision tree techniques used for classification of a dataset. They provide a set of rules that you can apply to a new (unclassified) dataset to predict which records will have a given outcome. CART segments a dataset by creating 2-way splits while CHAID segments using chi square tests to create multi-way splits. CART typically requires less data preparation than CHAID.

Nearest neighbor method: A technique that classifies each record in a dataset based on a combination of the classes of the k record(s) most similar to it in a historical dataset (where k 1). Sometimes called the k-nearest neighbor technique.

Rule induction: The extraction of useful if-then rules from data based on statistical significance.

Data visualization: The visual interpretation of complex relationships in multidimensional data. Graphics tools are used to illustrate data relationships.

While there is much research and much attention has been given to the retail aspect of data mining, the scientific and technical aspect of data mining has been under-researched and largely ignored. This is unfortunate, because there is a vast need for the ability to collect and sort through the universe of technical data is that is stored in the warehouses of technical libraries and data storages, but harnessing that information has heretofore been problematic. The present invention is an attempt to address this shortcoming and provide a method of datamining particularly well-suited for mining technical and scientific data.

### SUMMARY OF THE INVENTION

The present invention is a data mining solution for scientists, engineers, and technical professionals that can operate across multiple platforms and assimilate multiple formats to create a single data presentation that can be readily used by the user. The invention also offers a standardized format that can be used throughout industries for data transfer and storage that can greatly simplify exchange of information in the future among companies, universities, and the like. The present invention is a cost effective and time saving method to collect technical, scientific, and engineering data and present the data in a uniform standardized statistical analyzer. Specifically, the present invention gathers data from several disparate data files and file types into a single spreadsheet workbook, and then offers a variety of features to perform statistical analysis and graphing of the data during import.

These and other features of the invention will be best understood with reference to the detailed description of the preferred embodiments of the present invention along with the accompanying figures.

### BRIEF DESCRIPTION OF THE DRAWINGS

FIG. 1 a general depiction of a graphic user interface

FIG. 2 is an exemplary spreadsheet populated by search results;

FIG. 3 is an exemplary spreadsheet listing possible data file targets;

FIG. 4 is the tabulation portion of the graphic user interface;

FIG. 5 is a tabulated results of the sample search;

FIG. 6 is a sample data file;

FIG. 7 is a portion of the GUI accenting the file naming and Search criteria;

FIG. 8 is a pop up window as part of a query issued by the software;

FIG. 9 is a table showing raw and tabulated data from the search results;

FIG. 10 is the portion of the GUI where the file name and directory location are entered;

FIG. 11 is the data analysis portion of the GUI;

FIG. 12 is an example of a partially filled out data analysis portion of the GUI;

FIG. 13 is a spreadsheet showing the analyzed and plotted data of the search results;

FIG. 14 is an enlarged graph of the data plot;

FIG. 15 is the portion of the GUI where files are saved; and

FIG. 16 is a flow chart of the operation of the software.

### DETAILED DESCRIPTION OF THE PREFERRED EMBODIMENTS

The datamining, tabulation, analysis, and graphing software of the present invention is developed to fulfill a requirement for engineers and scientists to export data from several different formats into one format (such as, for example, Microsoft Excel®) and then allow the user to manipulate the data. The software has the feature through a user GUI interface (FIG. 1) in tabulating, analyzing, and graphing of the data. The graphic user interface shown in FIG. 1 allows the user to enter multiple inputs and is divided into three distinct sections: a data import section, a data manipulation section, and a data search section.

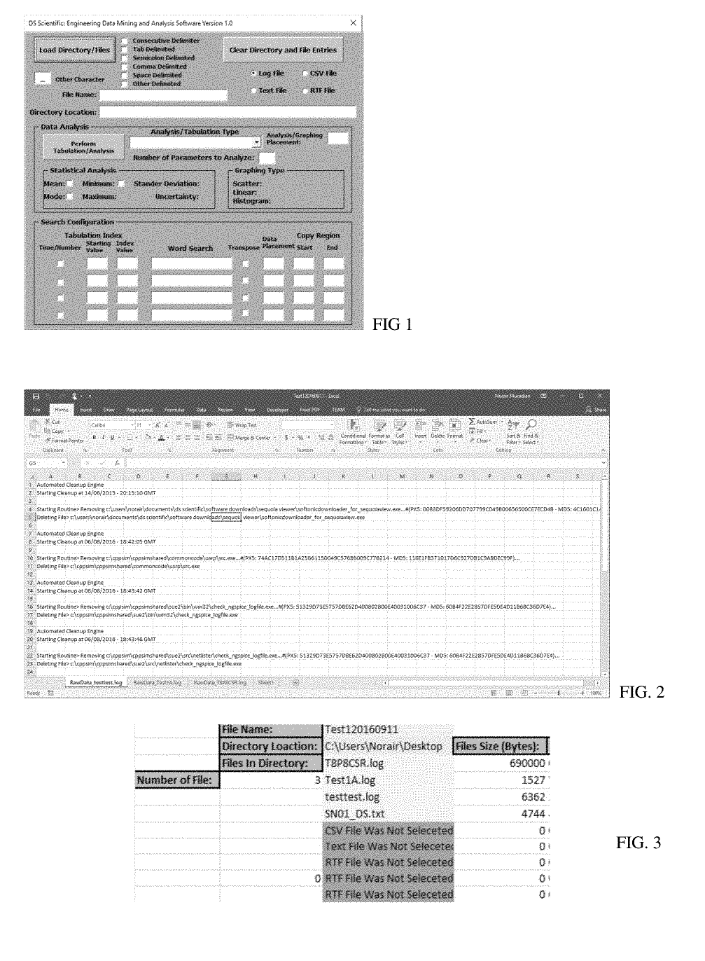

In the data import section, it is noted that the data can be imported from four different file types into a spreadsheet with a multiple types of delimitations. In order to import the data into a spreadsheet the data import parameters need to be configured. This is done by first selecting the file types in which the file directory contains, e.g., Log, CSV, Text, and/or RTF. Single or multiple file types can be chosen. The Reset button clears the file types that have been chosen. Next, the required delimiter types are selected, where multiple delimiter types can be chosen. If “Other Delimited” is checked or chosen, the character, letter, or number in the text edit field can be placed to the right. A default value of_is chosen. In the next step, to load the directory one can copy the directory path and directory name in the corresponding edit boxes or one can press the Load Directory/Files button and navigate to the directory folder. The Select Excel Workbook(s) Folder GUI will appear, allowing you to navigate to the folder directory. In the next step, the user presses the “OK” button. A message GUI appears instructing the user on how many files it has found, e.g., “3 Log files have been found.” Press the Yes or No button to continue. Clicking the Yes button causes the software to continue processing the files whereas clicking the No button stops the program. The software then opens a new spreadsheet workbook and populates the results of the director Log files into the workbooks, one file for every workbook. An exemplary spreadsheet is illustrated in FIG. 2.

The software saves a copy of the spreadsheet file in the directory where the data resides (See FIG. 3).

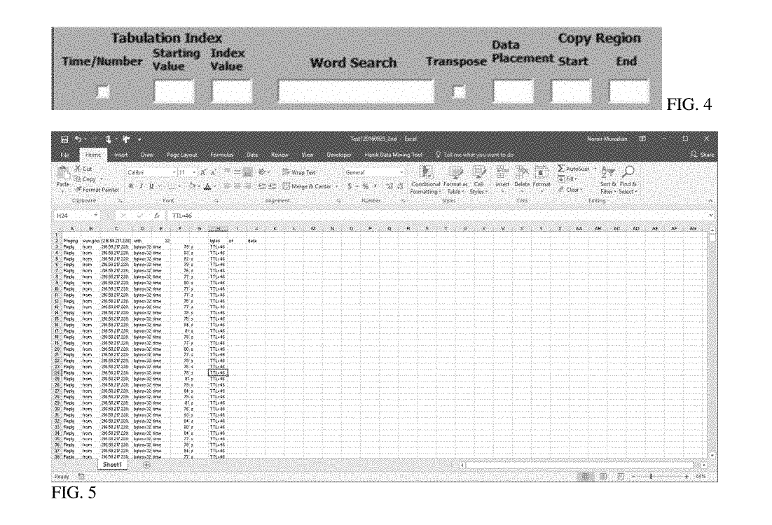

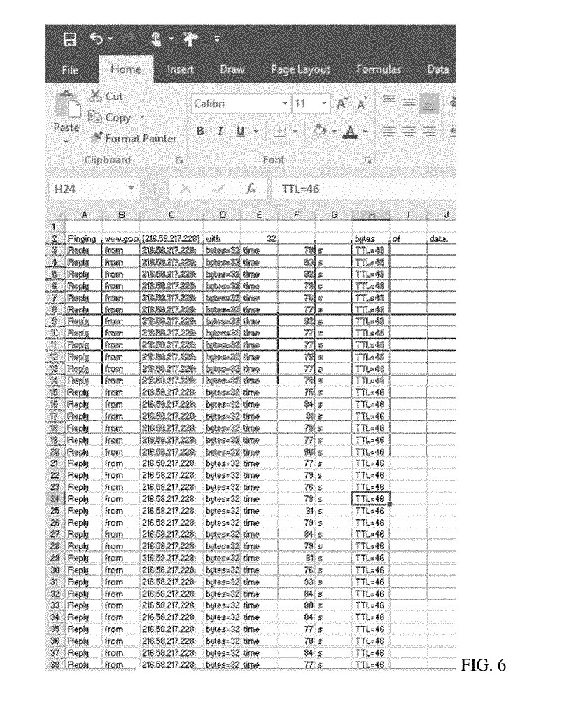

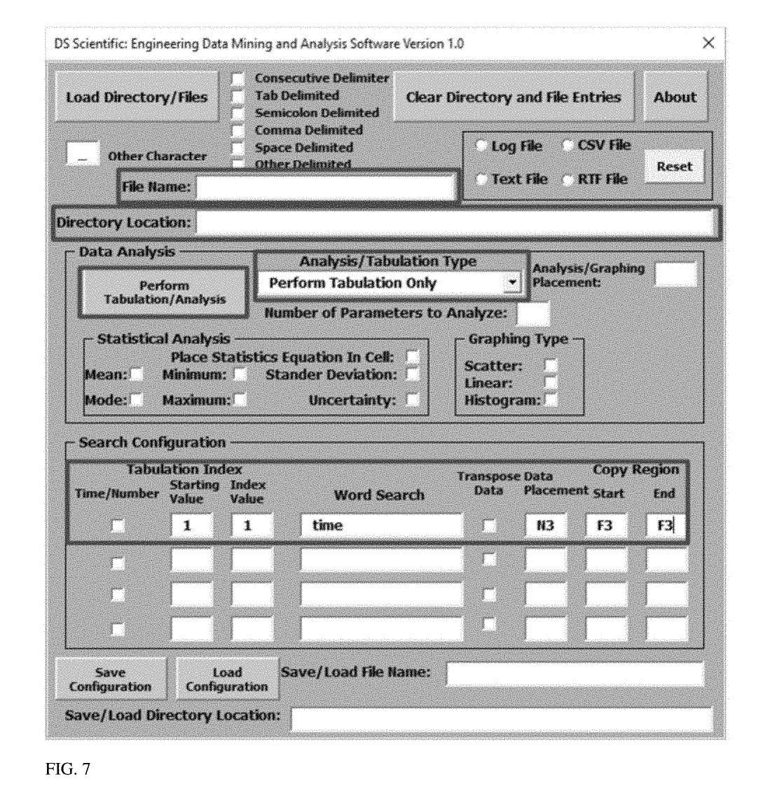

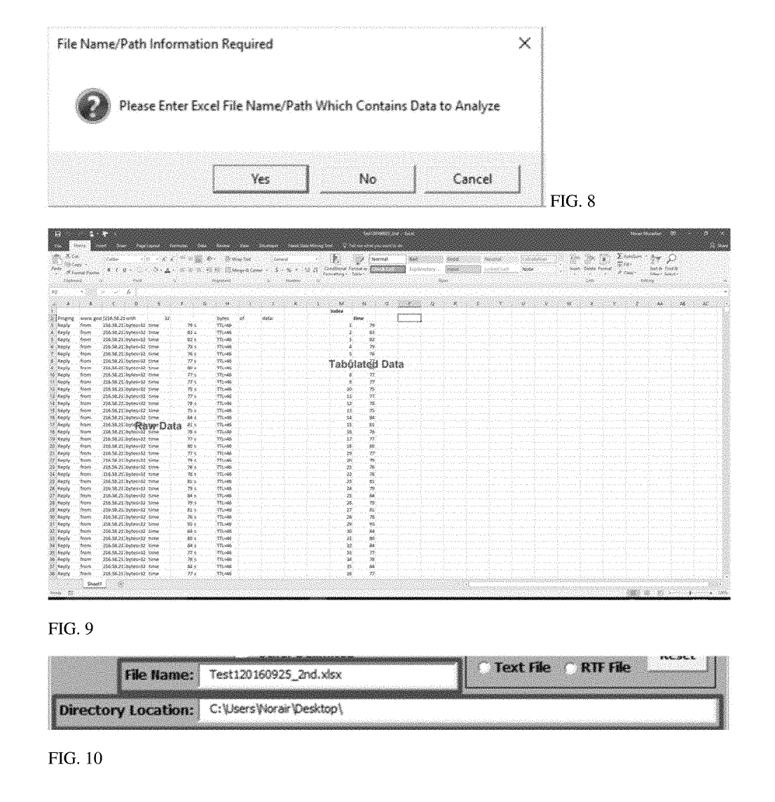

The section of the GUI that controls the parameter search and tabulation of the data is referred to as the Search Configuration section. The search configuration allows a user to find four search parameters of the imported data and tabulate the data for further processing. In one preferred embodiment, each parameter shown in FIG. 4 needs to be set in order for the engineering data mining software to properly tabulate the information for further processing.

The Search Configuration section is separated into four sub-sections: 1) a Tabulation Index; 2) a Word Search; 3) the Data Placement; and 4) the Copy Region. The Tabulation Index is composed of a Time/Number check box, a Starting Value text box, and an Index Value text box. The Time/Number check box allows the data to be indexed as a function of a time or a number. By checking the check box, the search is indexed all the tabulated data with a time stamp that can be modified for any time frame. For example, assume that a search imported the data of a voltage value as a function of time research and a user sought to search the data set and tabulate the results with an incrementing index of time. The Starting Value text box allows the user to begin the indexing at a set number, for example, beginning at a time stamp of 100 sec. One merely needs to type in 100 in the start value text box top to begin the data set at this incremental value. The Index Value indicates how often the data will repeat, e.g., 50 times, 100 times, etc.

The Word Search section also provides the word to find in the imported spreadsheet workbook that the associated data is correlated too. For example, if you typed in the word “Temperature,” since the data is correlated to temperature measurements that was taken. Also provided is the Transpose check box, which by checking allows the data to be tabulated horizontally, but if unchecked the data is be tabulated vertically in the worksheet. This is followed by the Data Placement text box which that allows the user to tabulate the data in any part of the worksheet. The software shifts to the left until any empty range of cells are found that match the size of the tabulation range. The copy region is only utilized if the transpose check box is checked and place the data range in the start of the data placement cell. The following two examples illustrate how to utilize the search configurations.

In the first example the data mining software tool is instructed to find and tabulate the data of an IP ping results. In order, to first tabulate the data it is helpful to review the data itself to have a better understanding of what the software is instructed to accomplish.

Reviewing just the data set in FIG. 5, one can determine that for this example the user is interested in the ping time. One can look for a word that one can use as the word search in this data set which one can utilize for the reference point where one can point to the data set, in this case it's the word “time” with the data starting in cell F3 (the latency of the ping testing). One can also choose words in the spreadsheet such as “reply” or “from.” The key is that it repeats throughout the spreadsheet work book for every word there is a corresponding data of latency.

To review what has been configured thus far in the GUI in the example, the Perform Tabulation Only from the Analysis/Tabulation Type was chosen from the pull down menu. Then, in the Search Configuration the starting Value as 1 was selected and the index value as 1, meaning that the data would increment by 1. The word search is “time,” which is the word that the software searches for. The Data Placement is in Cell N3, the software tabulates the data in cell N3. The region where the actual data is going to be copied starting from F3 which is the latency of the ping results. One does not need to populate the file name or directory location unless one has already imported the data because the software prompts the user for the directory and file information. If one presses the Perform Tabulation/Analysis button, the software prompts the user to enter the file that the user wants to tabulate.

Press the Yes button to continue. The Select Excel File GUI appears, and one navigates to the folder and chooses the file that one wants to tabulate. Then one presses the Open button. The software tool then begins tabulating the raw data on the left of the spreadsheet work book to the new location N3 on the right of the work book.

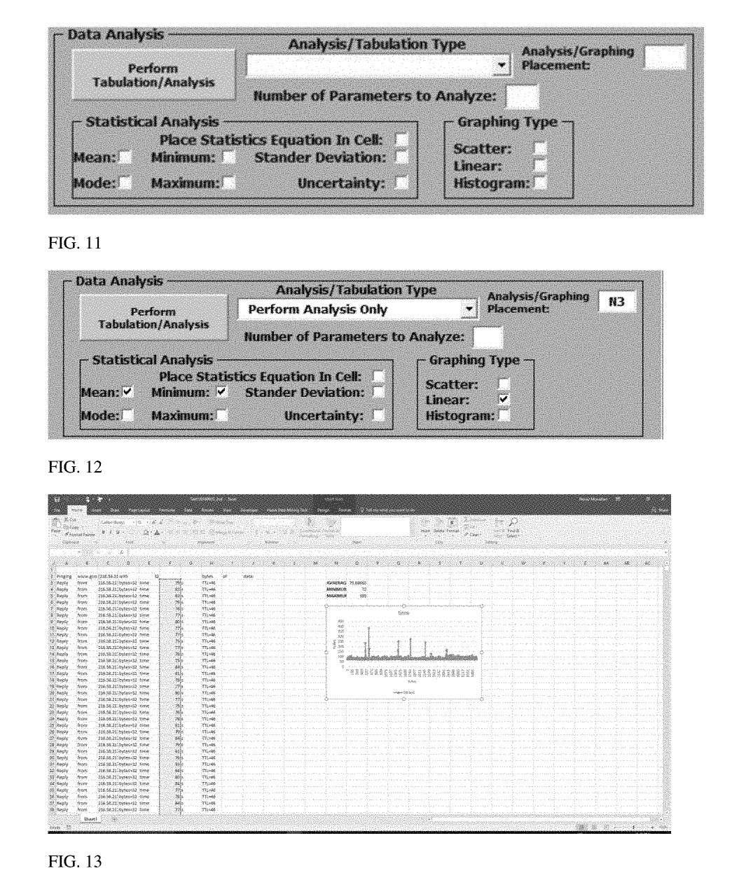

After completion of the tabulation, the Data Mining software populates the file and folder information on the user GUI. The section of the GUI which controls the analysis and graphing of the data is referred to as the data manipulation section refer to FIG. 11.

The Data Analysis section is divided into three sections. The first section allows a user to choose all the statistical analysis that needs to be performed. The second section is a graphing section that allows a user to select the graphs that will be required. The third section is a general controls section that determines where the data is placed. This section reviews the procedure for configuring the data mining GUI to perform the analysis required by the user.

The user starts by choosing the Perform Analysis Only on the pull-down tab on the Analysis/Tabulation type. The user then chooses any type of analysis to be performed and any type of graphing that would be required. In the Analysis/Graphing Placement the user chooses the cell where the software is to place the results. Then in the search configuration one can choose the word search and copy region. For example, in the ping data from the tabulation section, the user may require some analysis to be performed on the data. In this case, the user may check the Mean, Minimum, and Maximum value buttons, and also select a linear graphing type to display a latency results and place the results in cell N3.

Once the options have been selected, in the word Search the word “time” is entered and in the Data Placement cell F3 (location where the data starts) is entered. After all the fields have been entered, the Perform Tabulation/Analysis button is pressed to begin the analysis process. As indicated in the tabulation section, if one does not enter the file name and directory location the data mining software instructs the user to choose the file for which the analysis is to be performed. The data mining software then retrieves and analyzes the data, and the results are shown below.

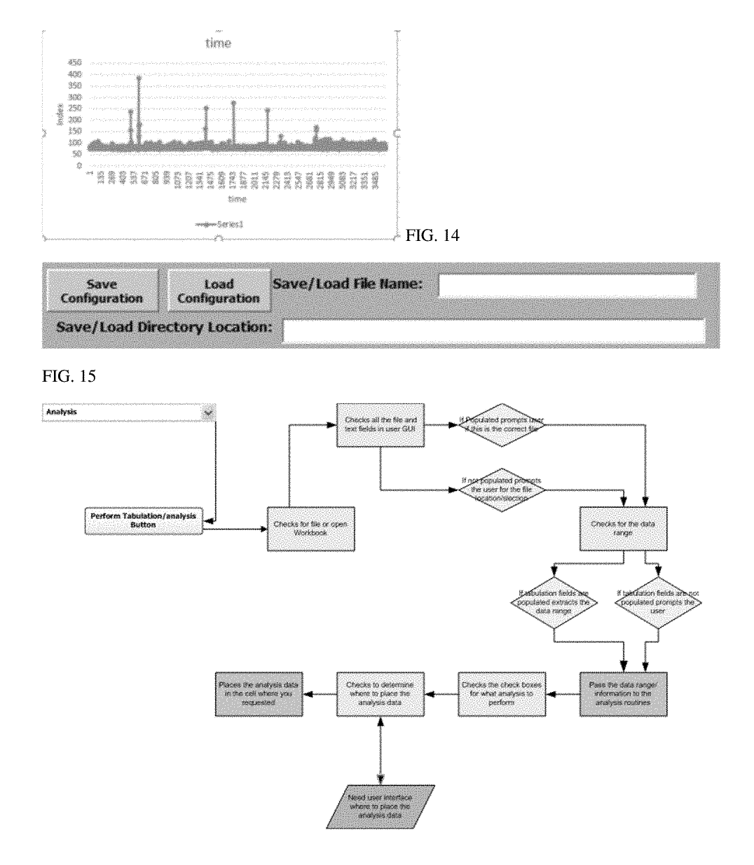

The inset plot of the data in FIG. 13 is shown in FIG. 14 greater detail. The section of the GUI that controls the saving and loading of the configuration files is design for the end user to save the configuration for later usage. This portion of the data mining software saves the work as a text file and then recalls the text file for future utilization. To begin, one can either type in the file name and directory location or press the Save Configuration button and the software will instruct the user as to where to save the configuration file. To load the configuration file, the process is similar in that the user can either type in the information of the user fields or press the Load Configuration button to navigate to the location of the configuration file required to load.

The data mining software of the present invention provides a novel and useful tool for scientific personnel, engineers, and those working with technical information to mine the information across multiple platforms in a cost efficient and time saving manner, and then prepare the data for analysis in a common text file or spreadsheet without regard for the original format of the data. This breakthrough saves many man-hours of time collecting and formatting data into a usable format so that it can be incorporated into forms or other documents that are regularly prepared by such professionals.

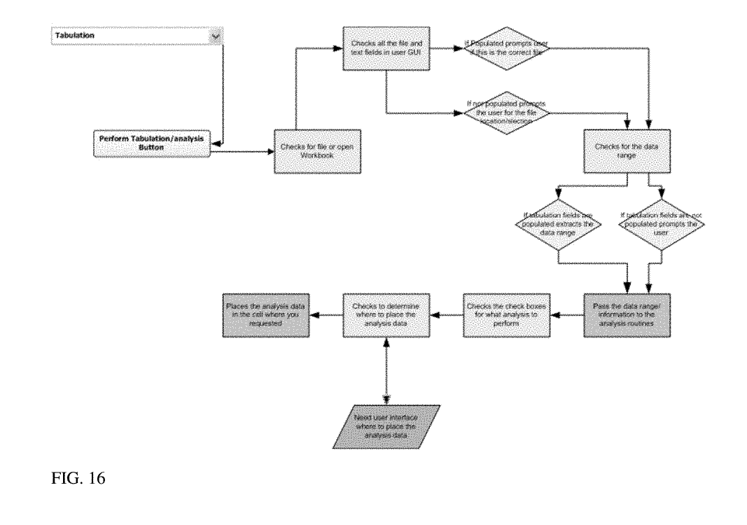

FIG. 16 is an operational flow chart of the software in two parts. The first part begins with an analysis pull down menu that triggers by the perform tabulation/analysis button. This step is followed by the step where a file or open workbook is performed, and then the step of checking for all the file and text fields in the user GUI. If the field is populated, the program checks to see if the file is correct, and if not populated the program prompts the user to enter the correct file location. The program then progresses to the step of checking to see if the data is in range, and extracts data within range if the tabulation fields are populated and prompts the user if the tabulation fields are missing or not data is in range. The data is then passed in the next step to the analysis routines, and the program investigates which boxes are checked to determine the selected analyses. The program then sends the results to a user selected data file, once the user has entered the desired location for the data in the preceding step.

The tabulation part of the program mirrors the analysis portion in several respects. The tabulation begins with a tabulation pull down menu that triggers by the perform tabulation/analysis button. This step is followed by the step where a file or open workbook is performed, and then the step of checking for all the file and text fields in the user GUI. If the field is populated, the program checks to see if the file is correct, and if not populated the program prompts the user to enter the correct file location. The program then progresses to the step of checking to see if the data is in range, and extracts data within range if the tabulation fields are populated and prompts the user if the tabulation fields are missing or not data is in range. The data is then passed in the next step to the analysis routines, and the program investigates which boxes are checked to determine the selected analyses. The program then sends the results to a user selected data file, once the user has entered the desired location for the data in the preceding step.

It should be understood that while specific examples have been provided in this disclosure, the invention is not limited to any specific embodiment or example. Rather, the invention is more broadly defined by claims to be provided in the non-provisional application based on the teachings herein. Accordingly, nothing in this disclosure should be read or interpreted as limiting in any manner, other than where expressly stated.

We claim:

1. A data mining method for engineers and scientists to export data from several different formats into a single format, comprising:
providing a graphic user interface having a data import section, a data manipulation section, and a data search section;
importing data using the data import section from among various different file types by selecting a file type, selecting required delimiter types, and loading a directory;
opening a new spreadsheet workbook and populating a results of a director log file into the workbook;
saving a copy of the spreadsheet file in the directory where the data resides;
employing a search configuration section having four subparts, including tabulation index, word search, data placement, and copy region;
indexing all tabulated data with a time stamp;
using the word search to find the spreadsheet workbook associated with specified data;
using the data placement to tabulate data in any part of the worksheet; and
using the copy region to place a start of data in a data placement cell.
